(19) United States
(12) Patent Application Publication
(10) Pub. No.: US 2026/0250068 A1
(43) Pub. Date: Aug. 27, 2026

(54) OVERHEAD TRANSPORT SYSTEM

(71) Applicant: Murata Machinery, Ltd., Kyoto-shi, Kyoto (JP)

(72) Inventors: Tatsuya YAMADA, Kyoto-shi (JP); Eiji WADA, Kyoto-shi (JP)

(21) Appl. No.: 19/159,383

(22) PCT Filed: Jan. 16, 2024
(86) PCT No.: PCT/JP2024/001012

§ 371 Date: Aug. 25, 2025

(30) Foreign Application Priority Data
Apr. 18, 2023 (JP) 2023-068094

(51) Int. Cl. B65G 1/04; B61B 13/06

(52) U.S. Cl. CPC B65G 1/0457; B61B 13/06; B65G 1/0464

(57) ABSTRACT

An overhead transport system includes an overhead transport vehicle including a traveling portion to travel along an overhead rail, a gripper configured to grip an article, and a lateral mover to move the gripper in a lateral direction and a support to support the lateral mover in a case where the gripper is moved in the lateral direction by the lateral mover. The lateral mover includes a slider slidable relative to a transport vehicle body in the lateral direction, a protrusion protruding upward from the slider, and a contact provided at the protrusion to move in the lateral direction while being in contact with the support when the gripper is moved in the lateral direction by the lateral mover.

### BACKGROUND OF THE INVENTION

### 1. Field of the Invention

The present disclosure relates to overhead transport systems.

### 2. Description of the Related Art

Japanese Patent No. 6477439 discloses an article transport facility (overhead transport system) including a transport apparatus, a transport target part serving as an origin of transportation or a destination of transportation of an article by the transport apparatus, and a support. The transport apparatus of such an article transport facility includes a traveling portion that travels along a travel route, a first support portion (gripper) that supports the article, and a second driver (lateral mover) that moves a second support portion that suspends and supports the first support portion in the width direction of the route. The second support portion is provided with a supported part (contact) supported by the support. The supported part is spaced away from a transport vehicle body (a portion connecting the traveling portion and the second support portion) in the longitudinal direction of the route (traveling direction) and the downward direction via a connector.

### SUMMARY OF THE INVENTION

In the overhead transport system as described above, since the contact is supported by the support when the gripper is moved by the lateral mover, the inclination of the lateral mover is suppressed. However, since the contact is spaced away from the transport vehicle body in the traveling direction and the downward direction, the dimensions of the lateral mover in the height direction and the traveling direction tend to increase, and there is a risk that the lateral mover interferes with another member (for example, Cableveyor (registered trademark) ). Therefore, it is desired that the size of the lateral mover is reduced.

Example embodiments of the present invention provide overhead transport systems each capable of suppressing inclination of a lateral mover and reducing a size of the lateral mover.

An overhead transport system according to an example embodiment of the present disclosure includes an overhead transport vehicle including a traveling portion to travel along an overhead rail, a gripper to grip an article, and a lateral mover to move the gripper in a lateral direction and a support to support the lateral mover in a case where the gripper is moved in the lateral direction by the lateral mover, in which the lateral mover includes a slider to slide relative to a transport vehicle body in the lateral direction, a protrusion protruding upward from the slider, and a contact provided at the protrusion and movable in the lateral direction while being in contact with the support when the gripper is moved in the lateral direction by the lateral mover.

According to the overhead transport system of the present example embodiment, since the lateral mover is supported by the support when the gripper is moved in the lateral direction by the lateral mover, the inclination of the lateral mover can be suppressed. In addition, since the contact can be provided above the slider, the dimensions of the lateral mover in the height direction and the traveling direction can be reduced. Therefore, according to an example embodiment of the present disclosure, it is possible to suppress the inclination of the lateral mover, as well as reduce the size of the lateral mover.

In an overhead transport system according to an example embodiment of the present invention, the support may be directly or indirectly connected to an overhead structure. In this case, connection of the support can be realized using the overhead structure.

In an overhead transport system according to an example embodiment of the present invention, the gripper may move up and down relative to the lateral mover. In this case, the article can be transferred by being moved up and down by the gripper.

In an overhead transport system according to an example embodiment of the present invention, the contact may include a roller rotatably supported by the protrusion with an axis along a traveling direction of the overhead transport vehicle as the rotation axis, and the support may support the roller from below. In this case, when the gripper is moved in the lateral direction by the lateral mover, the lateral mover can be supported by the support using the roller.

In an overhead transport system according to an example embodiment of the present invention, the roller may be provided in a pair, and the pair of rollers may sandwich the protrusion in the traveling direction of the overhead transport vehicle. In this case, since the pair of rollers come into contact with the support, the lateral mover can be stably supported by the support.

In an overhead transport system according to an example embodiment of the present invention, the support may include a pair of support portions to support each of the pair of rollers and a connector to connect the pair of support portions to each other. In this case, the support can be specifically configured.

In an overhead transport system according to an example embodiment of the present invention, each of the pair of support portions may have a plate shape elongated in the lateral direction, a tapered surface may be provided on an upper surface of an end portion of at least one of the pair of support portions, the tapered surface being inclined downward from a center of the support portion toward an end portion side, and at least one of the pair of rollers may ride on the tapered surface when the gripper is moved in the lateral direction by the lateral mover. In this case, when the gripper is moved in the lateral direction by the lateral mover, and the roller comes into contact with the support portion, the roller rides on the tapered surface. As a result, the roller can be easily brought into contact with the upper surface of the support portion.

In an overhead transport system according to an example embodiment of the present invention, the lateral mover may include an auxiliary contact spaced away from the contact in the lateral direction and movable in the lateral direction while contacting the support before the contact when the gripper is moved in the lateral direction by the lateral mover. In this case, when the gripper is moved in the lateral direction by the lateral mover, the movement of the lateral mover can be guided by the auxiliary contact in a manner that the contact moves toward the support. As a result, the contact can be easily brought into contact with the support.

In an overhead transport system according to an example embodiment of the present invention, the protrusion and the contact may be located at a central portion of the lateral mover in a traveling direction of the overhead transport vehicle. In this case, the lateral mover can be more stably supported by the support.

In an overhead transport system according to an example embodiment of the present invention, the overhead transport vehicle may further include a rotator provided between the lateral mover and the gripper to rotate the gripper about a rotation axis along a vertical direction, and the contact may include a first contact located to one side of the rotation axis in the lateral direction and a second contact located to the other side of the rotation axis in the lateral direction. Accordingly, even when the rotator is provided, the first contact is located to one side of the rotation axis in the lateral direction, and the second contact is located to the other side of the rotation axis in the lateral direction, thus allowing the lateral mover to be more stably supported by the support.

In an overhead transport system according to an example embodiment of the present invention, the lateral mover may include another slider located above the slider and capable of sliding relative to the transport vehicle body in the lateral direction, the slider may be capable of sliding relative to another slider in the lateral direction, another slider may include a pair of rails extending in the lateral direction and sandwiching the contact in a traveling direction, the pair of rails guiding the sliding of the slider, and a connector that connects the pair of rails to each other, and the connector may extend in a traveling direction while passing above the contact and being inflected so as to surround the contact as viewed in the lateral direction. Since the connector does not interfere with the contact even when the lateral mover includes another slider and the connector as described above, the size of the lateral mover can be reduced.

In an overhead transport system according to an example embodiment of the present invention, the support may include a first support located to one side of the overhead transport vehicle in the lateral direction and a second support located to the other side of the overhead transport vehicle in the lateral direction, the lateral mover may move the gripper in one direction and the other direction of the lateral direction, and the contact may move in the lateral direction while being in contact with the first support when the gripper is moved in one direction of the lateral direction by the lateral mover and move in the lateral direction while being in contact with the second support when the gripper is moved in the other direction of the lateral direction by the lateral mover. Even when the article is moved by moving the gripper in one direction and the other direction of the lateral direction as described above, the inclination of the lateral mover can be suppressed, and the size of the lateral mover can be reduced.

An overhead transport system according to an example embodiment of the present invention may further include a storage shelf including a mount on which the article is mounted, in which the support may define the storage shelf. In this case, in the overhead transport system that stores the article in the storage shelf, the inclination of the lateral mover can be suppressed, and the size of the lateral mover can be reduced.

According to example embodiments of the present disclosure, it is possible to provide overhead transport systems in each of which an inclination of a lateral mover is reduced or prevented, and a size of the lateral mover can be reduced.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a front view illustrating an overhead transport vehicle system according to an example embodiment of the present invention.

FIG. 2 is a perspective view illustrating the overhead transport system.

FIG. 3 is a perspective view illustrating a contact.

FIG. 4A is a perspective view illustrating a first support.

FIG. 4B is another perspective view illustrating the first support.

FIG. 5 is a side view illustrating an overhead transport vehicle.

FIG. 6A is a front view illustrating a case where an upper slider and/or a lower slider slides toward a first storage shelf in the lateral direction.

FIG. 6B is a front view illustrating the continuation of FIG. 6A.

FIG. 6C is a front view illustrating the continuation of FIG. 6B.

FIG. 7A is a front view illustrating a case where the upper slider and/or the lower slider slides toward a second storage shelf in the lateral direction.

FIG. 7B is a front view illustrating the continuation of FIG. 7A.

FIG. 7C is a front view illustrating the continuation of FIG. 7B.

### DETAILED DESCRIPTION OF THE EXAMPLE EMBODIMENTS

Hereinafter, example embodiments of the present invention will be described in detail with reference to the drawings. In the description of the drawings, the same or corresponding elements are denoted by the same reference numerals, and redundant description is omitted.

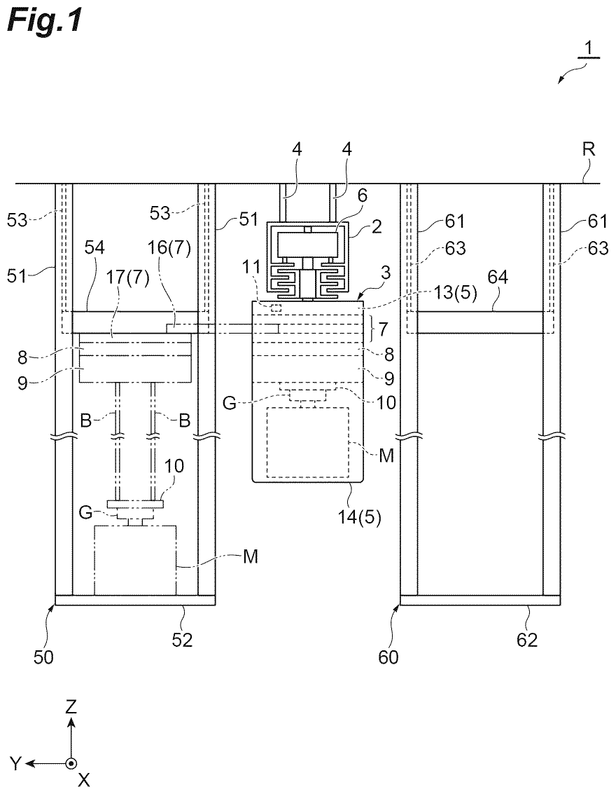

As illustrated in FIG. 1, an overhead transport system 1 is a system for transporting an article M using an overhead transport vehicle 3 movable along an overhead rail 2. The overhead transport system 1 includes the overhead rail 2, the overhead transport vehicle 3, a first storage shelf 50, and a second storage shelf 60. The overhead rail 2 is laid near an overhead R which is the space above the head of a worker in a factory or the like. The overhead rail 2 is suspended and supported by, for example, a supporting column 4. The overhead transport system 1 uses the overhead transport vehicle 3 to transfer the article M between, for example, the first storage shelf 50 and the second storage shelf 60. The article M is, for example, a FOUP (front opening unified pod) that houses a semiconductor wafer or a reticle pod that houses a reticle.

The overhead transport vehicle 3 is an overhead traveling-type unmanned traveling vehicle. The overhead transport vehicle 3 includes a frame 5, a traveling portion 6, a lateral mover 7, a rotator 8, a vertical driver 9, a gripper 10, and a transport vehicle controller 11.

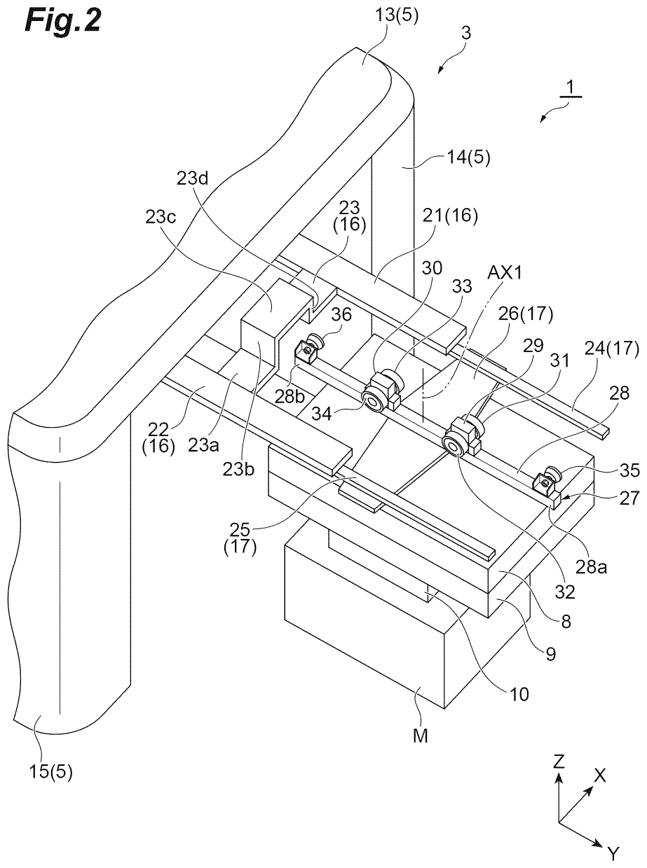

The frame 5 includes a center frame (transport vehicle body) 13, a front frame 14, and a rear frame 15 (see FIG. 2). The front frame 14 extends downward from one end portion of the center frame 13 in an X direction, which is the traveling direction of the overhead transport vehicle 3. The rear frame 15 extends downward from the other end portion of the center frame 13 in the X direction.

As illustrated in FIGS. 1 and 2, the lateral mover 7 is disposed below the center frame 13. The lateral mover 7 moves the rotator 8, the vertical driver 9, and the gripper 10 along a Y direction, which is a lateral direction intersecting the X direction. The lateral mover 7 includes an upper slider (another slider) 16 and a lower slider (slider) 17 disposed below the upper slider 16. The upper slider 16 is capable of sliding relative to the center frame 13 in both sides of the Y direction. The lower slider 17 is capable of sliding relative to the upper slider 16 in both sides of the Y direction. Accordingly, the lateral mover 7 can move the gripper 10 in the positive direction and the negative direction of the Y direction.

The rotator 8 is provided between the lower slider 17 of the lateral mover 7 and the gripper 10. The rotator 8 rotates the vertical driver 9 and the gripper 10 about a rotation axis AX1 (see FIG. 2) along a Z direction (vertical direction) perpendicular to the X direction and the Y direction. The vertical driver 9 is disposed below the rotator 8. The vertical driver 9 moves the gripper 10 up and down by unwinding and winding a plurality of belts B connected to the gripper 10. The gripper 10 is disposed below the vertical driver 9. The gripper 10 is movable upward and downward by the vertical driver 9. The gripper 10 includes a pair of grippers G that can be opened and closed along the XY plane. The gripper 10 holds a flange (not illustrated) of the article M by the pair of grippers G.

The transport vehicle controller 11 is disposed in the center frame 13. The transport vehicle controller 11 is an electronic control unit including a CPU (central processing unit), a ROM (read only memory), a RAM (random access memory), and the like. The transport vehicle controller 11 is configured or programmed to control each element or component of the overhead transport vehicle 3. The transport vehicle controller 11 may be configured or programmed to include a plurality of electronic control units. Furthermore, the transport vehicle controller 11 may be disposed in the front frame 14 or the like.

The first storage shelf 50 is a side track buffer (STB) disposed to one side of the overhead rail 2 in the Y direction. The first storage shelf 50 is suspended and supported by a plurality of shelf supporting columns 51. The first storage shelf 50 includes a mount 52 on which the article M is mounted. The first storage shelf 50 includes a first support 54 suspended and supported by a plurality of supporting columns 53. The first support 54 is directly connected to the overhead R via the plurality of supporting columns 53.

The second storage shelf 60 is a side track buffer (STB) disposed to the other side of the overhead rail 2 in the Y direction. The second storage shelf 60 is suspended and supported by a plurality of shelf supporting columns 61. The second storage shelf 60 includes a mount 62 on which the article M is mounted. The second storage shelf 60 includes a second support 64 suspended and supported by a plurality of supporting columns 63. The second support 64 is directly connected to the overhead R via the plurality of supporting columns 63.

In the overhead transport system 1 configured as described above, the overhead transport vehicle 3 operates, for example, as follows. When transferring the article M from the overhead transport vehicle 3 to the first storage shelf 50, the overhead transport vehicle 3 stops at the side of the first storage shelf 50. At the stopping position, the lateral mover 7 moves the gripper 10 toward the first storage shelf 50, and the gripper 10 is located immediately above the mount 52 of the first storage shelf 50. Then, the vertical driver 9 lowers the gripper 10, and the article M is mounted on the mount 52. The overhead transport vehicle 3 operates in the same manner as described above when transferring the article M to the second storage shelf 60 as well.

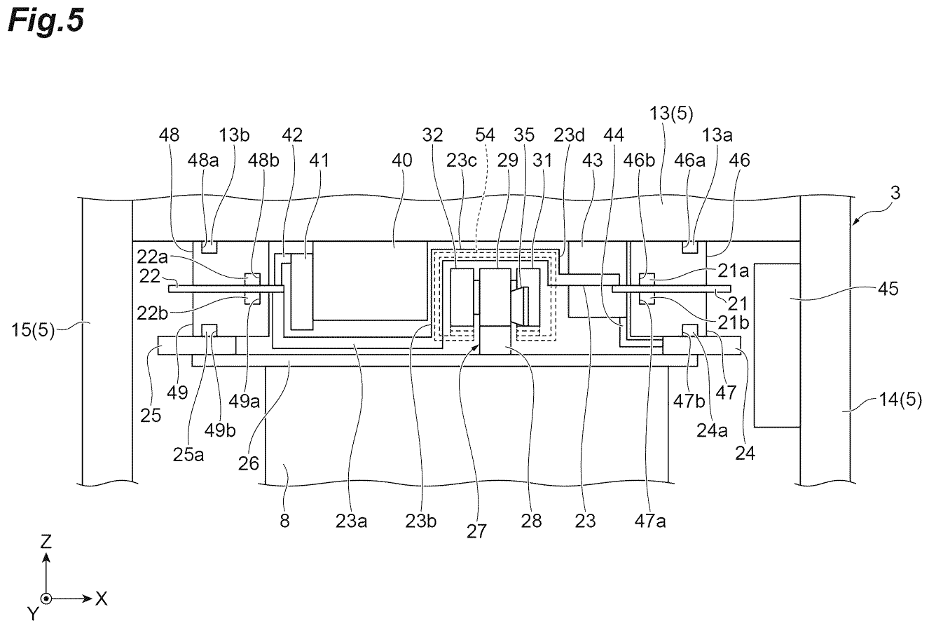

Next, configurations of the upper slider 16 and the lower slider 17 of the lateral mover 7 will be described with reference to FIGS. 2 and 5.

The upper slider 16 includes a pair of upper rails 21 and 22 that extend along the Y direction and are aligned in the X direction, an upper connector (connector) 23 that connects the upper rails 21 and 22 to each other, an upper guide block 46, and an upper guide block 48. The upper rails 21 and 22 guide the sliding of the lower slider 17. The upper rail 21 is located closer to the front frame 14 (see FIG. 1) than the upper rail 22 in the X direction. The upper connector 23 is located between lower rails 24 and 25 and the center frame 13. The upper connector 23 is a plate elongated in the X direction.

The lower slider 17 includes the pair of lower rails 24 and 25 that extend along the Y direction and are aligned in the X direction, a lower connector 26 that connects the lower rails 24 and 25 to each other, a lower guide block 47, and a lower guide block 49. The lower rail 24 is capable of sliding relative to the upper rail 21, and the lower rail 25 is capable of sliding relative to the upper rail 22. The lower rail 24 is located closer to the front frame 14 (see FIG. 1) than the lower rail 25 in the X direction. The lower connector 26 is located between the lower rails 24 and 25 and the rotator 8. The lower connector 26 is a plate elongated in the X direction. The lower connector 26 has, for example, a hexagonal shape in plan view.

The upper rails 21 and 22 sandwich first rollers 31 and 32 and second rollers 33 and 34 described later in the X direction. The lower rails 24 and 25 sandwich the first rollers 31 and 32 and the second rollers 33 and 34 in the X direction.

The upper guide block 46, the lower guide block 47, the upper guide block 48, and the lower guide block 49 are disposed below the center frame 13 and above the lower connector 26. The upper guide block 46, the lower guide block 47, the upper guide block 48, and the lower guide block 49 are, for example, linear motion guide (LM guide) blocks.

The upper guide block 46 is provided between the center frame 13 and the upper rail 21 and between the front frame 14 and a driven belt 43 described later. The upper guide block 46 is capable of sliding relative to each of the center frame 13 and the upper rail 21 along the Y direction.

An upper groove 46a opening upward is at the top of the upper guide block 46. A guide protrusion 13a that protrudes downward from the bottom of the center frame 13 is engaged with the upper groove 46a so as to be capable of sliding along the Y direction. The upper groove 46a and the guide protrusion 13a extend along the Y direction. A lower groove 46b opening downward is at the bottom of the upper guide block 46. A guide protrusion 21a that protrudes upward from the top of the upper rail 21 is engaged with the lower groove 46b so as to be capable of sliding along the Y direction. The lower groove 46b and the guide protrusion 21a extend along the Y direction.

The lower guide block 47 is provided between the upper rail 21 and the lower rail 24 and between the front frame 14 and the driven belt 43. The lower guide block 47 is capable of sliding relative to each of the upper rail 21 and the lower rail 24 along the Y direction.

An upper groove 47a opening upward is at the top of the lower guide block 47. A guide protrusion 21b that protrudes downward from the bottom of the upper rail 21 is engaged with the upper groove 47a so as to be capable of sliding along the Y direction. The upper groove 47a and the guide protrusion 21b extend along the Y direction. A lower groove 47b opening downward is at the bottom of the lower guide block 47. A guide protrusion 24a that protrudes upward from the top of the lower rail 24 is engaged with the lower groove 47b so as to be capable of sliding along the Y direction. The lower groove 47b and the guide protrusion 24a extend along the Y direction.

The upper guide block 48 is provided between the center frame 13 and the upper rail 22 and between the rear frame 15 and a driving belt 41 described later. The upper guide block 48 is capable of sliding relative to each of the center frame 13 and the upper rail 22 along the Y direction.

An upper groove 48a opening upward is at the top of the upper guide block 48. A guide protrusion 13b that protrudes downward from the bottom of the center frame 13 is engaged with the upper groove 48a so as to be capable of sliding along the Y direction. The upper groove 48a and the guide protrusion 13b extend along the Y direction. A lower groove 48b opening downward is at the bottom of the upper guide block 48. A guide protrusion 22a that protrudes upward from the top of the upper rail 22 is engaged with the lower groove 48b so as to be capable of sliding along the Y direction. The lower groove 48b and the guide protrusion 22a extend along the Y direction.

The lower guide block 49 is provided between the upper rail 22 and the lower rail 25 and between the rear frame 15 and the driving belt 41. The lower guide block 49 is capable of sliding relative to each of the upper rail 22 and the lower rail 25 along the Y direction.

An upper groove 49a opening upward is at the top of the lower guide block 49. A guide protrusion 22b that protrudes downward from the bottom of the upper rail 22 is engaged with the upper groove 49a so as to be capable of sliding along the Y direction. The upper groove 49a and the guide protrusion 22b extend along the Y direction. A lower groove 49b opening downward is at the bottom of the lower guide block 49. A guide protrusion 25a that protrudes upward from the top of the lower rail 25 is engaged with the lower groove 49b so as to be capable of sliding along the Y direction. The lower groove 49b and the guide protrusion 25a extend along the Y direction.

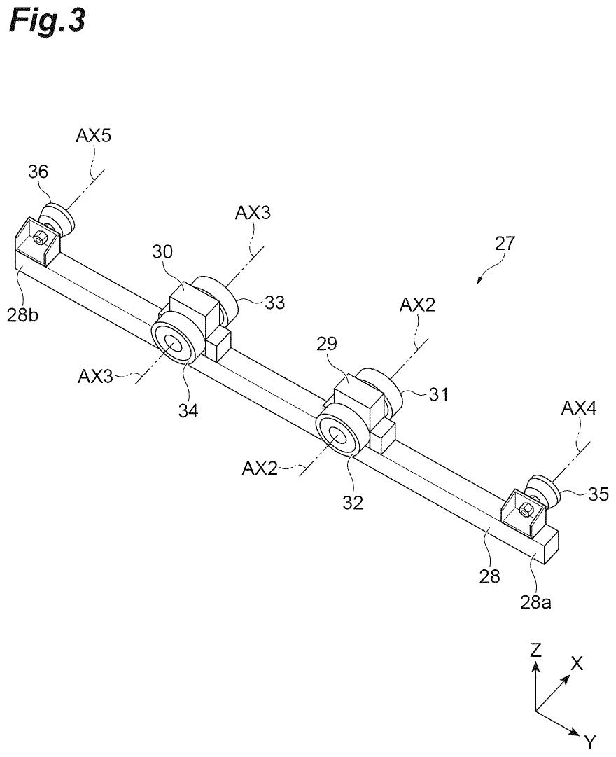

As shown in FIGS. 2 and 3, the lateral mover 7 includes a contact 27 disposed on the lower connector 26. The contact 27 includes a bar-shaped structure 28, a first protrusion (protrusion) 29, a second protrusion (protrusion) 30, the pair of first rollers (first contacts) 31 and 32, the pair of second rollers (second contacts) 33 and 34, a first guide roller (auxiliary contact) 35, and a second guide roller (auxiliary contact) 36. The bar-shaped structure 28 extends along the Y direction. The bar-shaped structure 28 is disposed above the lower connector 26 and between the lower rails 24 and 25 in the X direction. The bar-shaped structure 28 includes end portions 28a and 28b in the Y direction. The end portion 28a is located closer to the first storage shelf 50 (see FIG. 1) than the end portion 28b in the Y direction. The end portion 28b is located closer to the second storage shelf 60 (see FIG. 1) than the end portion 28a in the Y direction.

The first protrusion 29 and the second protrusion 30 are provided on the bar-shaped structure 28 so as to protrude upward from the lower slider 17. The first protrusion 29 and the second protrusion 30 are located at the central portion of the lateral mover 7 in the X direction. The first protrusion 29 is located closer to the end portion 28a than the rotation axis AX1 in the Y direction, and the second protrusion 30 is located closer to the end portion 28b than the rotation axis AX1 in the Y direction.

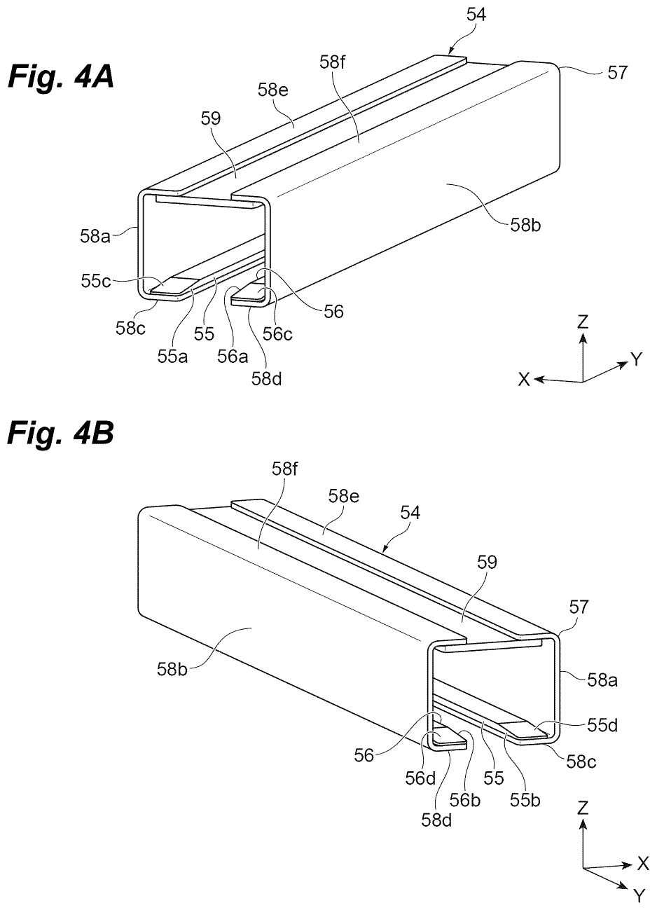

The first rollers 31 and 32 are supported by the first protrusion 29 so as to be rotatable with an axis along the X direction as a rotation axis AX2. The first rollers 31 and 32 sandwich the bar-shaped structure 28 and the first protrusion 29 in the X direction. The first roller 31 is located closer to the lower rail 24 than the first protrusion 29 in the X direction, and the first roller 32 is located closer to the lower rail 25 than the first protrusion 29 in the X direction. When the gripper 10 is moved in the Y direction by the lateral mover 7, each of the first rollers 31 and 32 rolls (moves) in the Y direction while being in contact with each of a pair of support portions 55 and 56 (see FIGS. 4A and 4B) described later. Each of the first rollers 31 and 32 may be in direct contact with each of the support portions 55 and 56, or may be in indirect contact with each of the support portions 55 and 56 via another structural element such as a protective film.

The second rollers 33 and 34 are supported by the second protrusion 30 so as to be rotatable with an axis along the X direction as a rotation axis AX3. The second rollers 33 and 34 sandwich the bar-shaped structure 28 and the second protrusion 30 in the X direction. The second roller 33 is located closer to the lower rail 24 than the second protrusion 30 in the X direction, and the second roller 34 is located closer to the lower rail 25 than the second protrusion 30 in the X direction. When the gripper 10 is moved in the Y direction by the lateral mover 7, each of the second rollers 33 and 34 rolls in the Y direction while being in contact with each of the pair of support portions 55 and 56 (see FIGS. 4A and 4B) described later. Each of the second rollers 33 and 34 may be in direct contact with each of the support portions 55 and 56, or may be in indirect contact with each of the support portions 55 and 56 via another structural element such as a protective film.

The first rollers 31 and 32 are located to one side (end portion 28a side) of the rotation axis AX1 in the Y direction, and the second rollers 33 and 34 are located to the other side (end portion 28b side) of the rotation axis AX1 in the Y direction. The first rollers 31 and 32 and the second rollers 33 and 34 are located near the center of the bar-shaped structure 28 in the Y direction. The first rollers 31 and 32 and the second rollers 33 and 34 are located at the central portion of the lateral mover 7 in the X direction.

The first guide roller 35 is supported by the end portion 28a of the bar-shaped structure 28 so as to be rotatable with an axis along the X direction as a rotation axis AX4. The first guide roller 35 protrudes relative to the bar-shaped structure 28 toward the lower rail 24 in the X direction. The first guide roller 35 is spaced away from the first roller 31 in the Y direction. When the gripper 10 is moved in the positive direction of the Y direction by the lateral mover 7, the first guide roller 35 rolls in the Y direction while contacting the support portion 55 (see FIGS. 4A and 4B) before the first roller 31. The first guide roller 35 may be in direct contact with the support portion 55, or may be in indirect contact with the support portion 55 via another structural element such as a protective film.

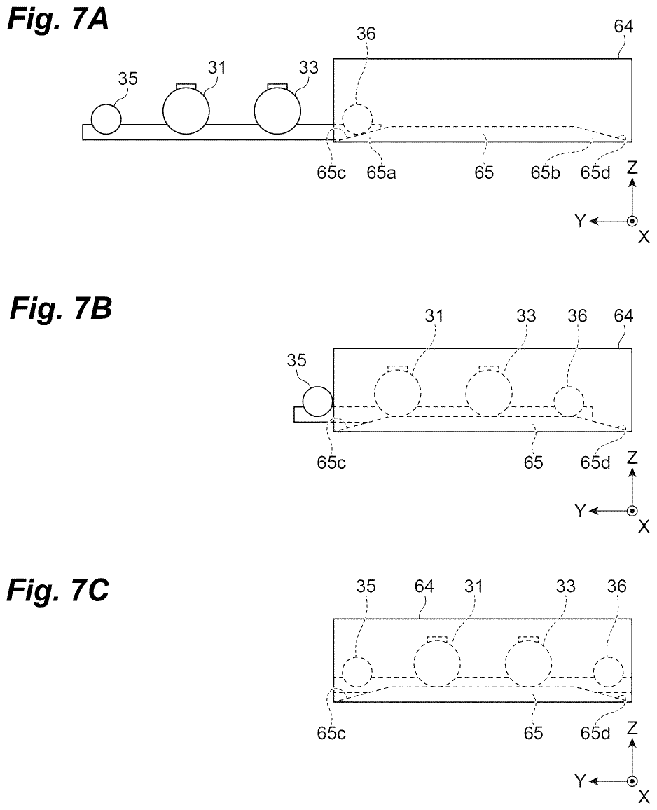

The second guide roller 36 is supported by the end portion 28b of the bar-shaped structure 28 so as to be rotatable with an axis along the X direction as a rotation axis AX5. The second guide roller 36 protrudes relative to the bar-shaped structure 28 toward the lower rail 24 in the X direction. The second guide roller 36 is spaced away from the second roller 33 in the Y direction. When the gripper 10 is moved in the negative direction of the Y direction by the lateral mover 7, the second guide roller 36 rolls in the Y direction while contacting a support portion 65 (see FIGS. 7A to 7C) before the second roller 33. The second guide roller 36 may be in direct contact with the support portion 65, or may be in indirect contact with the support portion 65 via another structural element such as a protective film.

The outer diameters of the first rollers 31 and 32 and the second rollers 33 and 34 are larger than the outer diameters of the first guide roller 35 and the second guide roller 36. The lower ends of the first rollers 31 and 32 and the second rollers 33 and 34 and the lower ends of the first guide roller 35 and the second guide roller 36 are located on the same plane. The outer diameters of the shafts of the first rollers 31 and 32 and the second rollers 33 and 34 are larger than the outer diameters of the shafts of the first guide roller 35 and the second guide roller 36. The first rollers 31 and 32 share the common shaft, and the first rollers 31 and 32 rotate integrally. In the same manner, the second rollers 33 and 34 share the common shaft, and the second rollers 33 and 34 rotate integrally.

The configurations of the first support 54 and the second support 64 will be described with reference to FIGS. 4A, 4B, and 7A. The first support 54 supports the lateral mover 7 when the gripper 10 is moved in the Y direction by the lateral mover 7. As illustrated in FIGS. 4A and 4B, the first support 54 includes the pair of support portions 55 and 56 and a connector 57. The support portion 55 is located on one side in the X direction, and the support portion 56 is located on the other side in the X direction.

The support portion 55 is a portion that is in contact with the first roller 31 and the second roller 33 (see FIG. 3), and is also a portion that supports the first roller 31 and the second roller 33. The support portion 55 has a plate shape elongated in the Y direction. The support portion 55 has end portions 55a and 55b in the Y direction. The end portion 55a is located farther in the negative direction of the Y direction than the end portion 55b. A tapered surface 55c inclined downward from the center of the support portion 55 toward the end portion 55a is provided on the upper surface of the end portion 55a of the support portion 55. A tapered surface 55d inclined downward from the center of the support portion 55 toward the end portion 55b is provided on the upper surface of the end portion 55b of the support portion 55.

The support portion 56 is in contact with the first roller 32 and the second roller 34 (see FIG. 3), and also supports the first roller 32 and the second roller 34. The support portion 56 has a plate shape elongated in the Y direction. The support portion 56 includes end portions 56a and 56b in the Y direction. The end portion 56a is located farther in the negative direction of the Y direction than the end portion 56b. A tapered surface 56c inclined downward from the center of the support portion 56 toward the end portion 56a is provided on the upper surface of the end portion 56a of the support portion 56. A tapered surface 56d inclined downward from the center of the support portion 56 toward the end portion 56b is provided on the upper surface of the end portion 56b of the support portion 56.

The connector 57 includes side panels 58a and 58b and a top panel 59. The side panel 58a is located on one side in the X direction, and the side panel 58b is located on the other side in the X direction. The side panel 58a has a U-shaped cross section opening toward the side panel 58b in the X direction, and the side panel 58b has a U-shaped cross section opening toward the side panel 58a in the X direction. A lower end portion 58c of the side panel 58a and a lower end portion 58d of the side panel 58b in the Z direction extend so as to face each other in the X direction. The support portion 55 is provided on the end portion 58c, and the support portion 56 is provided on the end portion 58d. An upper end portion 58e of the side panel 58a and an upper end portion 58f of the side panel 58b in the Z direction extend so as to face each other in the X direction. The top panel 59 has a plate shape elongated in the Y direction. The top panel 59 connects the end portion 58e and the end portion 58f to each other. Thus, the support portions 55 and 56 are connected to each other by the connector 57.

As illustrated in FIG. 7A, the second support 64 has the support portion 65. The support portion 65 is a portion that is in contact with the first roller 31 and the second roller 33 (see FIG. 3), and is also a portion that supports the first roller 31 and the second roller 33. The support portion 65 has a plate shape elongated in the Y direction. The support portion 65 includes end portions 65a and 65b in the Y direction. The end portion 65a is located farther in the positive direction of the Y direction than the end portion 65b. A tapered surface 65c inclined downward from the center of the support portion 65 toward the end portion 65a is provided on the upper surface of the end portion 65a of the support portion 65. A tapered surface 65d inclined downward from the center of the support portion 65 toward the end portion 65b is provided on the upper surface of the end portion 65b of the support portion 65. Similarly to the first support 54, the second support 64 has a support portion (not illustrated) paired with the support portion 65.

Arrangements of the structures inside the frame 5 will be described with reference to FIG. 5. The first support 54 is schematically illustrated in FIG. 5. The lateral mover 7 includes a driver 40, the driving belt 41, a bracket 42, the driven belt 43, and a bracket 44. The driver 40, the driving belt 41, the bracket 42, the driven belt 43, and the bracket 44 are disposed below the center frame 13 and above the lower connector 26.

The driver 40 moves the upper slider 16 and the lower slider 17 in the Y direction. The driver 40 is located between the contact 27 and the rear frame 15 in the X direction. The driving belt 41 is fed to both sides in the Y direction by the driving force of the driver 40. The driving belt 41 is located between the driver 40 and the upper rail 22 in the X direction. The driving belt 41 and the upper rail 22 are connected to each other by the bracket 42. The center frame 13 and the upper rail 22 are connected to each other via the driving belt 41. The upper rail 22 slides relative to the center frame 13 by the driving force of the driver 40.

The driven belt 43 moves the upper rail 21 and the lower rail 24 in the Y direction. The driven belt 43 is configured to be fed to both sides in the Y direction by following the movement of the upper rail 22 and the lower rail 25. The driven belt 43 is located between the contact 27 and front frame 14 in the X direction. The driven belt 43 and the lower rail 24 are connected to each other by the bracket 44. The center frame 13, the upper rail 21, and the lower rail 24 are connected to each other via the driven belt 43. The upper rail 21 slides relative to the center frame 13 in accordance with the sliding operation of the upper rail 22. The lower rail 24 slides relative to the upper rail 21 via the driven belt 43. The lower rail 25 slides relative to the upper rail 22 in accordance with the sliding operation of the lower rail 24.

The lateral mover 7 includes a cable protector 45. The cable protector 45 protects wiring for operating the lateral mover 7. The cable protector 45 is, for example, Cableveyor (registered trademark). The cable protector 45 is disposed below the center frame 13 and between the front frame 14 and the upper rail 21 and the lower rail 24. The cable protector 45 is disposed below the center frame 13 and between the rear frame 15 and the upper rail 22 and the lower rail 25.

The contact 27 is provided between the center frame 13 and the lower connector 26 and between the driver 40 and the driven belt 43. The contact 27 is accommodated in the lateral mover 7 in a state where the upper slider 16 and the lower slider 17 do not slide. Therefore, the height of the lateral mover 7 in the Z direction does not change regardless of the presence or absence of the contact 27. Furthermore, the contact 27 does not interfere with the cable protector 45 or the like when the upper slider 16 and the lower slider 17 slide.

The shape of the upper connector 23 will be described with reference to FIGS. 2 and 5. When viewed in the Y direction, the upper connector 23 passes above the first rollers 31 and 32 and the second rollers 33 and 34 (see FIG. 3), and extends in the X direction while being inflected so as to surround the first rollers 31 and 32 and the second rollers 33 and 34. Specifically, the upper connector 23 includes a first portion 23a, a second portion 23b connected to the first portion 23a, a third portion 23c connected to the second portion 23b, and a fourth portion 23d connected to the third portion 23c. The first portion 23a extends between the driver 40 and the lower connector 26 along the X direction. The second portion 23b extends between the first roller 32 and the driver 40 along the Z direction. The third portion 23c extends between the center frame 13 and the first rollers 31 and 32 along the X direction. The fourth portion 23d extends between the first roller 31 and the driven belt 43 along the Z direction. As described above, since the upper connector 23 includes the portions extending in the X direction or the Z direction, the upper connector 23 can connect the upper rails 21 and 22 to each other without interfering with the contact 27.

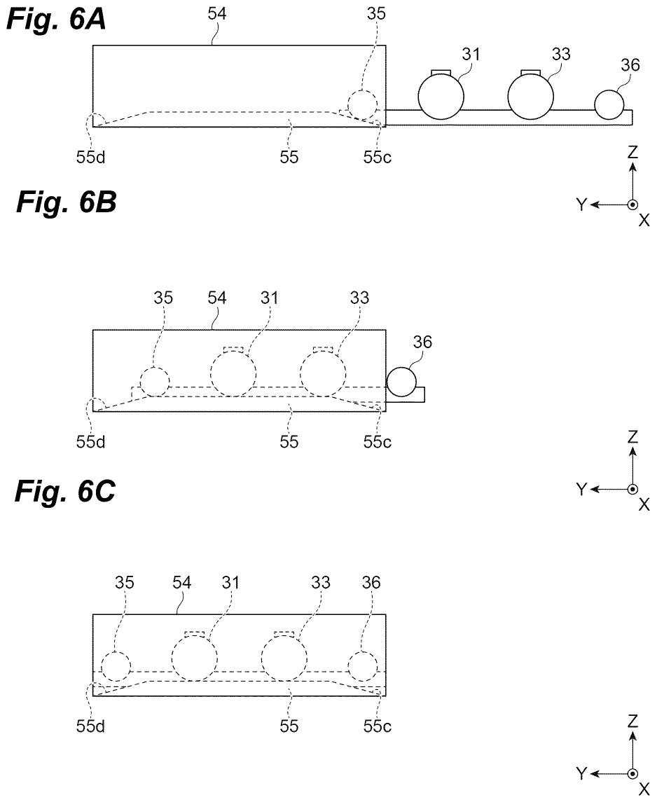

Next, the movement of the contact 27 in a case where the upper slider 16 and/or the lower slider 17 slides toward the first storage shelf 50 in the Y direction will be described. When the upper slider 16 and/or the lower slider 17 slides in the positive direction of the Y direction, the first guide roller 35 first rides on the tapered surface 55c as illustrated in FIG. 6A. Subsequently, when the upper slider 16 and/or the lower slider 17 slides, the first roller 31, the second roller 33, and the first guide roller 35 that ride on the tapered surface 55c roll on the support portion 55 in the positive direction of the Y direction, as illustrated in FIG. 6B. At the same time, the first roller 32 and the second roller 34 that ride on the tapered surface 56c roll on the support portion 56 (see FIGS. 3 and 4) in the positive direction of the Y direction. Subsequently, when the upper slider 16 and/or the lower slider 17 slides, and then the sliding of the upper slider 16 and the lower slider 17 is completed, the first roller 31 and the second roller 33 come into contact with the support portion 55, and the first roller 32 and the second roller 34 come into contact with the support portion 56, while each of the first guide roller 35 and the second guide roller 36 is positioned above each of the tapered surface 55d and the tapered surface 55c without coming into contact with the tapered surface 55d and the tapered surface 55c, as illustrated in FIG. 6C.

Next, the movement of the contact 27 in a case where the upper slider 16 and/or the lower slider 17 slides toward the second storage shelf 60 in the Y direction will be described. When the upper slider 16 and/or the lower slider 17 slide in the negative direction of the Y direction, the second guide roller 36 first rides on the tapered surface 65c as illustrated in FIG. 7A. Subsequently, when the upper slider 16 and/or the lower slider 17 slides, the first roller 31, the second roller 33, and the second guide roller 36 that ride on the tapered surface 65c roll on the support portion 65 in the negative direction of the Y direction, as illustrated in FIG. 7B. At the same time, the first roller 32 and the second roller 34 that ride on the tapered surface roll on the support portion in the negative direction of the Y direction. Subsequently, when the upper slider 16 and/or the lower slider 17 slides, and then the sliding of the upper slider 16 and the lower slider 17 is completed, the first roller 31 and the second roller 33 come into contact with the support portion 65, and the first roller 32 and the second roller 34 come into contact with the support portion, while each of the first guide roller 35 and the second guide roller 36 is positioned above each of the tapered surface 65c and the tapered surface 65d without coming into contact with the tapered surface 65c and the tapered surface 65d, as illustrated in FIG. 7C.

As described above, in the overhead transport system 1, the inclination of the lateral mover 7 can be suppressed, since the lateral mover 7 is supported by the first support 54 when the gripper 10 is moved in the Y direction by the lateral mover 7. In addition, since the first rollers 31 and 32 and the second rollers 33 and 34 can be provided above the lower slider 17, the dimensions of the lateral mover 7 in the Z direction and the X direction can be reduced. Therefore, according to the overhead transport system 1, it is possible to suppress the inclination of the lateral mover 7, as well as reduce the size of the lateral mover 7. Furthermore, according to the overhead transport system 1, it is possible to secure a degree of freedom in the arrangement of the structural elements in the overhead transport vehicle 3. The first support 54 is also a structure that secures a degree of freedom in the arrangement of the structural elements in the overhead transport vehicle 3 while supporting the lateral mover 7 of the overhead transport vehicle 3.

In the overhead transport system 1, the first support 54 is directly connected to the overhead R. In this case, connection of the first support 54 can be realized using the overhead R. Moreover, the stability of the first support 54 can be enhanced by directly connecting the first support 54 to the overhead R.

In the overhead transport system 1, the gripper 10 moves up and down relative to the lateral mover 7 by the vertical driver 9. In this case, the article M can be transferred by being moved up and down by the gripper 10. In addition, the upward and downward movement of the gripper 10 relative to the lateral mover 7 allows the article M to be moved over a broad range.

In the overhead transport system 1, the first rollers 31 and 32 are supported by the first protrusion 29 so as to be rotatable about the rotation axis AX2, and the second rollers 33 and 34 are supported by the second protrusion 30 so as to be rotatable about the rotation axis AX3. The first support 54 supports the first rollers 31 and 32 and the second rollers 33 and 34 from below. In this case, when the gripper 10 is moved in the Y direction by the lateral mover 7, the lateral mover 7 can be supported by the first support 54 using the first rollers 31 and 32 and the second rollers 33 and 34. Moreover, when the gripper 10 is moved in the Y direction by the lateral mover 7, the first rollers 31 and 32 and the second rollers 33 and 34 smoothly move on the first support 54. This allows the gripper 10 to be smoothly moved by the lateral mover 7.

In the overhead transport system 1, the first rollers 31 and 32 sandwich the first protrusion 29 in the X direction, and the second rollers 33 and 34 sandwich the second protrusion 30 in the X direction. In this case, since the first rollers 31 and 32 and the second rollers 33 and 34 come into contact with the first support 54, the lateral mover 7 can be stably supported by the first support 54.

In the overhead transport system 1, the first support 54 includes the support portions 55 and 56 supporting the first rollers 31 and 32, respectively, and the connector 57 connecting the support portions 55 and 56 to each other. In this case, the first support 54 can be specifically configured. Furthermore, since the support portions 55 and 56 are connected by the connector 57, the rigidity of the first support 54 can be enhanced.

In the overhead transport system 1, each of the support portions 55 and 56 has a plate shape elongated in the Y direction, the tapered surface 55c inclined downward from the center of the support portion 55 toward the end portion 55a is provided on the upper surface of the end portion 55a of the support portion 55, and the tapered surface 56c inclined downward from the center of the support portion 56 toward the end portion 56a is provided on the upper surface of the end portion 56a of the support portion 56. The first roller 31 rides on the tapered surface 55c when the gripper 10 is moved in the Y direction by the lateral mover 7. The first roller 32 rides on the tapered surface 56c when the gripper 10 is moved in the Y direction by the lateral mover 7. In this case, when the gripper 10 is moved in the Y direction by the lateral mover 7, and the first rollers 31 and 32 come into contact with the support portions 55 and 56, the first rollers 31 and 32 ride on the tapered surfaces 55c and 56c. As a result, the first rollers 31 and 32 can be easily brought into contact with the upper surfaces of the support portions 55 and 56.

In the overhead transport system 1, the lateral mover 7 includes the first guide roller 35 spaced away from the first roller 31 in the Y direction and configured to move in the Y direction while contacting the first support 54 before the first roller 31 when the gripper 10 is moved in the Y direction by the lateral mover 7. In this case, when the gripper 10 is moved in the Y direction by the lateral mover 7, the movement of the lateral mover 7 can be guided by the first guide roller 35 in a manner that the first roller 31 moves toward the first support 54. As a result, the first rollers 31 and 32 and the second rollers 33 and 34 can be easily brought into contact with the first support 54.

In the overhead transport system 1, the first protrusion 29, the second protrusion 30, the first rollers 31 and 32, and the second rollers 33 and 34 are located at the central portion of the lateral mover 7 in the X direction. In this case, the lateral mover 7 can be more stably supported by the first support 54.

In the overhead transport system 1, the overhead transport vehicle 3 includes the rotator 8 that is provided between the lateral mover 7 and the gripper 10 and rotates the gripper 10 about the rotation axis AX1 along the Z direction, the first rollers 31 and 32 are located to one side (end portion 28a side) of the rotation axis AX1 in the Y direction, and the second rollers 33 and 34 are located to the other side (end portion 28b side) of the rotation axis AX1 in the Y direction. Accordingly, even when the rotator 8 is provided, the first rollers 31 and 32 are located to one side of the rotation axis AX1 in the Y direction, and the second rollers 33 and 34 are located to the other side of the rotation axis AX1 in the Y direction, thus allowing the lateral mover 7 to be more stably supported by the first support 54. Moreover, the orientation of the gripper 10 can be adjusted by rotating the rotator 8. As a result, the orientation of the gripper 10 can be adjusted in accordance with the orientation of the article M, and the gripper 10 can hold the article M.

In the overhead transport system 1, the lateral mover 7 includes the upper slider 16 located above the lower slider 17 and capable of sliding relative to the center frame 13 in the Y direction, the lower slider 17 is capable of sliding relative to the upper slider 16 in the Y direction, the upper slider 16 includes the upper rails 21 and 22 extending in the Y direction and disposed so as to sandwich the first rollers 31 and 32 and the second rollers 33 and 34 in the X direction, the upper rails 21 and 22 guiding the sliding of the lower slider 17, and the upper connector 23 connects the upper rails 21 and 22 to each other, and the upper connector 23 extends in the X direction while passing above the first rollers 31 and 32 and the second rollers 33 and 34 and being inflected so as to surround the first rollers 31 and 32 and the second rollers 33 and 34 as viewed in the Y direction. Since the upper connector 23 does not interfere with the first rollers 31 and 32 and the second rollers 33 and 34 even when the lateral mover 7 includes the upper slider 16 and the upper connector 23 as described above, the size of the lateral mover 7 can be reduced.

The overhead transport system 1 includes the first support 54 located to one side of the overhead transport vehicle 3 in the Y direction and a second support 64 located to the other side of the overhead transport vehicle 3 in the Y direction, the lateral mover 7 moves the gripper 10 in the positive direction and the negative direction of the Y direction, and the first rollers 31 and 32 and the second rollers 33 and 34 move in the Y direction while being in contact with the first support 54 when the gripper 10 is moved in the positive direction of the Y direction by the lateral mover 7 and move in the Y direction while being in contact with the second support 64 when the gripper 10 is moved in the negative direction of the Y direction by the lateral mover 7. Even when the article M is moved by moving the gripper 10 in the positive direction and the negative direction of the Y direction as described above, the inclination of the lateral mover 7 can be suppressed, and the size of the lateral mover 7 can be reduced. In addition, the movement of the gripper 10 in the positive direction and the negative direction of the Y direction allows the article M to be moved over a broad range.

The overhead transport system 1 includes the first storage shelf 50 including a mount 52 on which the article M is mounted and the second storage shelf 60 having a mount 62, in which the first support 54 defines the first storage shelf 50, and the second support 64 defines the second storage shelf 60. In this case, in the overhead transport system 1 that stores the article M in the first storage shelf 50 and the second storage shelf 60, the inclination of the lateral mover 7 can be suppressed, and the size of the lateral mover 7 can be reduced.

In the overhead transport system 1, when the gripper 10 is moved in the Y direction by the lateral mover 7, the lateral mover 7 is supported by the first rollers 31 and 32 and the second rollers 33 and 34 of which the outer diameters are larger than the outer diameters of the first guide roller 35 and the second guide roller 36 and of which the shafts have the outer diameters that are larger than the outer diameters of the shafts of the first guide roller 35 and the second guide roller 36. Therefore, when the gripper 10 is moved in the Y direction by the lateral mover 7, the lateral mover 7 can be stably supported as compared with a case where the lateral mover 7 is supported by the first guide roller 35 and the second guide roller 36.

In the overhead transport system 1, when the sliding of the upper slider 16 and the lower slider 17 toward the first storage shelf 50 in the Y direction is completed, each of the first guide roller 35 and the second guide roller 36 is located above each of the tapered surface 55d and the tapered surface 55c. On the other hand, since the first roller 31 and the second roller 33 are provided near the center of the bar-shaped structure 28, the first roller 31 and the second roller 33 are kept in contact with the support portion 55. Similarly, the first roller 32 and the second roller 34 are kept in contact with the support portion 56. Similarly, when the sliding of the upper slider 16 and the lower slider 17 toward the second storage shelf 60 in the Y direction is completed, the first roller 31 and the second roller 33 are kept in contact with the support portion 65, and the first roller 32 and the second roller 34 are kept in contact with the support portion.

In the overhead transport system 1, even when the sliding distance (stroke) of the upper slider 16 and the lower slider 17 is long (for example, the sliding distance is about 860 mm), the first support 54 receives the moment generated by the lateral mover 7. With this configuration, the load on the traveling portion 6 can be reduced.

Although example embodiments have been described above, the present disclosure is not limited to the above example embodiments. Various modifications can be made without departing from the gist of the present disclosure.

In the above example embodiments, the connector 57 includes the side panels 58a and 58b and the top panel 59, but the side panels 58a and 58b and the top panel 59 may be integrated in the connector 57.

In the above example embodiments, the contact 27 includes the first rollers 31 and 32 and the second rollers 33 and 34, but the contact 27 may not include a roller. The contact 27 only needs to be movable on the first support 54 or the second support 64. The contact 27 may include a rotatable ball or a plate-shaped structure.

In the above example embodiments, the contact 27 includes two first rollers 31 and 32 and two second rollers 33 and 34, but the number of the first rollers and the number of the second rollers are not limited thereto. For example, the contact 27 may include one first roller, but not a second roller. In this case, one first roller may be provided at the central portion of the bar-shaped structure 28.

In the above example embodiments, the first rollers 31 and 32 and the second rollers 33 and 34 are included in the contact 27, but a rotatable roller may be provided in the first support 54 or the second support 64, and the contact 27 may move on the roller. In this case, the contact 27 may not include a roller, and the size of the lateral mover 7 can be further reduced.

In the above example embodiments, the first support 54 is directly connected to the overhead R by the plurality of supporting columns 53, but the first support 54 may be indirectly connected to the overhead R via the plurality of shelf supporting columns 51 or the mount 52, or may be indirectly connected to the overhead R via the overhead rail 2. The second support 64 may be indirectly connected to the overhead R via the plurality of shelf supporting columns 61 or the mount 62, or may be indirectly connected to the overhead R via the overhead rail 2.

In the above example embodiments, the first support 54 and the second support 64 may include a lightening portion. In this case, the weight of the first support 54 and the second support 64 can be reduced. The first support 54 and the second support 64 may be directly connected to the overhead R.

In the above example embodiments, the first rollers 31 and 32 share the common shaft, and the first rollers 31 and 32 rotate integrally, but the first rollers 31 and 32 may not share a common shaft. In this case, each of the first rollers 31 and 32 may rotate independently. Likewise, each of the second rollers 33 and 34 may rotate independently. In the above example embodiments, the lower connector 26 has a hexagonal shape in plan view, but the shape of the lower connector 26 is not particularly limited, and the lower connector 26 may have a rectangular shape in plan view. The lower connector 26 may be recessed downward.

While example embodiments of the present invention have been described above, it is to be understood that variations and modifications will be apparent to those skilled in the art without departing from the scope and spirit of the present invention. The scope of the present invention, therefore, is to be determined solely by the following claims.

1-13. (canceled)

14: An overhead transport system comprising:
an overhead transport vehicle including a traveling portion to travel along an overhead rail, a gripper to grip an article, and a lateral mover to move the gripper in a lateral direction; and
a support to support the lateral mover in a case where the gripper is moved in the lateral direction by the lateral mover; wherein
the lateral mover includes a slider to slide relative to a transport vehicle body in the lateral direction, a protrusion protruding upward from the slider, and a contact provided at the protrusion and movable in the lateral direction while being in contact with the support when the gripper is moved in the lateral direction by the lateral mover.

15: The overhead transport system according to claim 14, wherein the support is directly or indirectly connected to an overhead structure.

16: The overhead transport system according to claim 14, wherein the gripper is movable up and down relative to the lateral mover.

17: The overhead transport system according to claim 14, wherein
the contact includes a roller rotatably supported by the protrusion with an axis along a traveling direction of the overhead transport vehicle as a rotation axis; and
the support supports the roller from below.

18: The overhead transport system according to claim 17, wherein
the pair of rollers sandwich the protrusion in the traveling direction of the overhead transport vehicle.

19: The overhead transport system according to claim 18, wherein the support includes a pair of support portions to support each of the pair of rollers and a connector to connect the pair of support portions to each other.

20: The overhead transport system according to claim 19, wherein
each of the pair of support portions has a plate shape elongated in the lateral direction;
a tapered surface is provided on an upper surface of an end portion of at least one of the pair of support portions, the tapered surface being inclined downward from a center of the support portion toward an end portion side; and
at least one of the pair of rollers rides on the tapered surface when the gripper is moved in the lateral direction by the lateral mover.

21: The overhead transport system according to claim 14, wherein the lateral mover includes an auxiliary contact spaced away from the contact in the lateral direction and movable in the lateral direction while contacting the support before the contact when the gripper is moved in the lateral direction by the lateral mover.

22: The overhead transport system according to claim 14, wherein the protrusion and the contact are located at a central portion of the lateral mover in a traveling direction of the overhead transport vehicle.

23: The overhead transport system according to claim 14, wherein
the overhead transport vehicle further includes a rotator provided between the lateral mover and the gripper to rotate the gripper about a rotation axis along a vertical direction; and
the contact includes a first contact located to one side of the rotation axis in the lateral direction and a second contact located to the other side of the rotation axis in the lateral direction.

24: The overhead transport system according to claim 14, wherein
the lateral mover includes another slider located above the slider and slidable relative to the transport vehicle body in the lateral direction;
the slider is slidable relative to another slider in the lateral direction;
the another slider includes a pair of rails extending in the lateral direction and sandwiching the contact in a traveling direction, the pair of rails being positioned to guide the sliding of the slider, and a connector that connects the pair of rails to each other; and
the connector extends in a traveling direction while passing above the contact and surrounding the contact as viewed in the lateral direction.

25: The overhead transport system according to claim 14, wherein
the support includes a first support located to one side of the overhead transport vehicle in the lateral direction and a second support located to the other side of the overhead transport vehicle in the lateral direction;
the lateral mover is operable to move the gripper in one direction and the other direction of the lateral direction; and
the contact is movable in the lateral direction while in contact with the first support when the gripper is moved in one direction of the lateral direction by the lateral mover and is movable in the lateral direction while being in contact with the second support when the gripper is moved in the other direction of the lateral direction by the lateral mover.

26: The overhead transport system according to claim 14, further comprising:
a storage shelf including a mount on which the article is mounted; wherein
the support defines the storage shelf.
